(19) United States
(12) Patent Application Publication
(10) Pub. No.: US 2026/0089072 A1
(43) Pub. Date: Mar. 26, 2026

(54) INFORMATION PROCESSING DEVICE AND INFORMATION PROCESSING METHOD

(71) Applicant: Toshiba Tec Kabushiki Kaisha, Tokyo (JP)

(72) Inventor: Kurumi TODA, Mishima Shizuoka (JP)

(21) Appl. No.: 19/306,898

(22) Filed: Aug. 21, 2025

(30) Foreign Application Priority Data
Sep. 25, 2024 (JP) 2024-166351

(51) Int. Cl. H04L 41/22; G06Q 20/20; H04L 61/5007

(52) U.S. Cl. CPC H04L 41/22; G06Q 20/202; H04L 61/5007

(57) ABSTRACT

According to embodiments, an attendant terminal computer is configured to monitor a plurality of transaction processing apparatuses, the attendant terminal computer comprising: a display panel; a communication circuit configured to communicate with the plurality of transaction processing apparatuses; and a processing circuit configured to execute a program stored in memory of the attendant terminal computer to perform steps for managing the display panel, wherein the steps include: determining group identifiers associated with groups to which the plurality of transaction processing apparatuses are assigned; determining, based on the determined group identifiers, visual features for displaying monitoring information received via the communication circuit from the plurality of transaction processing apparatuses; and updating, for each of the groups, the display panel to display the monitoring information for one or more of the plurality of transaction processing apparatuses assigned to the group, in a manner that includes a determined visual feature of the group.

### CROSS-REFERENCE TO RELATED APPLICATION

This application is based upon and claims the benefit of priority from Japanese Patent Application No. 2024-166351, filed on Sep. 25, 2024, the entire contents of which are incorporated herein by reference.

### FIELD

Embodiments described herein relate generally to an information processing device and an information processing method.

### BACKGROUND

A full self-service register is widespread in which a commodity registration operation and checkout operation by a customer are possible. An attendant of a store uses an attendant terminal to monitor a plurality of full self-service registers installed in the store. The attendant terminal can display, in real time, information concerning the full self-service registers such as states of the full self-service registers and situations of change machines being used.

Concerning the display of the attendant terminal, from the viewpoint of perspicuity, it has been desired to display information concerning a large number of full self-service registers on one screen.

However, it is likely that, as the number of full self-service registers displayed on one screen increases, visibility of the display is deteriorated and efficiency of monitoring is accordingly deteriorated.

### BRIEF DESCRIPTION OF THE DRAWINGS

FIG. 1 is a block diagram exemplifying an information processing system according to some embodiments.

FIG. 2 is a block diagram exemplifying an attendant terminal according to some embodiments.

FIG. 3 is a diagram illustrating a configuration example of a group setting table according to some embodiments.

FIG. 4 is a diagram illustrating a configuration example of an allocation setting table according to some embodiments.

FIG. 5 is a diagram illustrating a display example of an allocation setting screen according to some embodiments.

FIG. 6 is a diagram illustrating a display example of a group setting screen according to some embodiments.

FIG. 7 is a diagram illustrating a display example of a list screen according to some embodiments.

FIG. 8 is a flowchart exemplifying processing for setting group information performed by a processing circuit of the attendant terminal.

FIG. 9 is a flowchart exemplifying processing for setting allocation information performed by the processing circuit.

FIG. 10 is a flowchart exemplifying processing for displaying a list screen performed by the processing circuit.

### DETAILED DESCRIPTION

An object of embodiments is to provide a technique for managing a display panel for improving the visibility of a display thereon for monitoring a plurality of transaction processing devices.

In general, according to embodiments, an attendant terminal computer is configured to monitor a plurality of transaction processing apparatuses that are used by customers for performing transactions. The attendant terminal computer comprises a display panel and a communication circuit configured to communicate with the plurality of transaction processing apparatuses. The attendant terminal computer further comprises a processing circuit configured to execute a program stored in memory of the attendant terminal computer, to perform steps for managing the display panel. The steps include: determining group identifiers associated with groups to which the plurality of transaction processing apparatuses are assigned; determining, based on the determined group identifiers, visual features for displaying monitoring information received via the communication circuit from the plurality of transaction processing apparatuses; and updating, for each of the groups, the display panel to display the monitoring information for one or more of the plurality of transaction processing apparatuses assigned to the group, in a manner that includes a determined visual feature of the group.

Several embodiments are explained below with reference to the drawings. Note that, throughout the drawings referred to in the following explanation of the embodiments, scales of units are sometimes changed as appropriate. In the drawings referred to in the following explanation of the embodiments, for explanation, components are sometimes omitted.

### Configuration Example

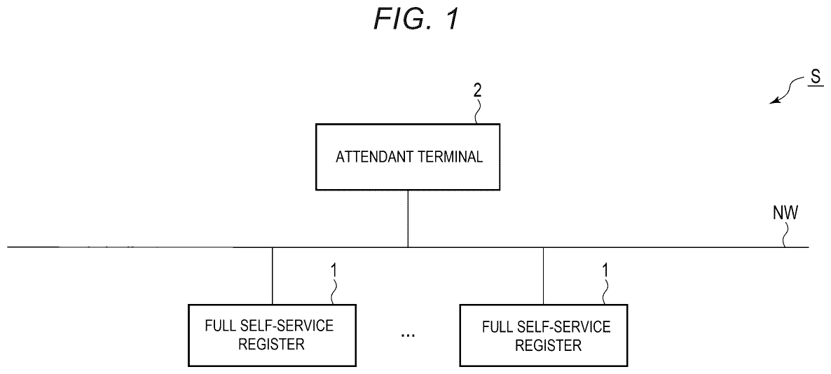

FIG. 1 is a block diagram exemplifying an information processing system S. The information processing system S is a system that performs communication among a plurality of devices and processes information concerning a transaction in a store. For example, the store may be, but is not limited to, a volume retailer such as a supermarket. The transaction may be, for example, a transfer of expenses from a customer to the store with respect to the sale of one or more commodities by the store. Accordingly, the transaction may include a sale of a commodity from the point of view of the store. The transaction may include a purchase of the commodity from the point of view of the customer. It should be noted that the commodity is not limited to an object but may also be a target such as a service or a ticket, which is not necessarily a tangible item. As used herein, “transaction” shall refer to a single transfer of expenses for a commodity, service, ticket, etc., unless particularly noted otherwise.

The information processing system S includes a plurality of full self-service registers 1 and an attendant terminal 2. The plurality of full self-service registers 1 and the attendant terminal 2 are devices in the store. Each of the plurality of full self-service registers 1 may be located at a different position in the store.

The devices included in the information processing system S are communicably connected to one another via a network NW. The network NW may be, e.g., a LAN (Local Area Network) or the like. For example, the network NW may be a wireless LAN or may be a wired LAN.

The information processing system S may include a plurality of attendant terminals 2.

Each full self-service register 1 is a device that processes a transaction in the store. Each full self-service register 1 is a POS (Point of sales) terminal including a commodity registration function and a checkout function, which may be performed by the customer using the POS terminal. Each full self-service register 1 is an example of a transaction processing device in which a checkout operation by the customer is possible.

As used herein, “commodity registration” is a process of designating a commodity for purchase before checkout of a transaction, i.e., before such purchase is carried out. A commodity that has been registered is referred to herein as a “registered commodity.” As used herein, “checkout” is a process for completing payment for a transaction, which may occur after the commodity registration. The checkout includes a means of settlement. Such means of settlement may be performed either online or offline.

As used herein, “offline settlement” is checkout not requiring cooperation with other devices via a network such as the Internet. For example, the offline settlement may be performed using cash, a cash voucher, and the like. The “cash voucher” is a certificate circulated in a form similar to cash currency. For example, the cash voucher may be, but is not limited to, a commodity certificate, a gift certificate, a rice coupon, a beer coupon, a shareholder gift certificate, a regional promotion coupon, or a coupon. The cash voucher may be either physical or virtual.

As used herein, “online settlement” is checkout that one of the full self-service registers 1 executes in cooperation with other devices via a network such as the Internet. For example, the online settlement may be performed using a credit card, electronic money, a debit card, a code, and the like.

The attendant terminal 2 is a computer used by an attendant of the store. For example, the attendant terminal 2 may be used by the attendant to monitor the plurality of self-service full self-service registers 1. The attendant terminal 2 may be a dedicated stationary device or may be a portable device such as a smartphone, a tablet terminal, or a PC (Personal Computer). The attendant terminal 2 is an example of an information processing device that processes information for a transaction. The attendant may be a store clerk. The attendant is an example of a user of the attendant terminal 2.

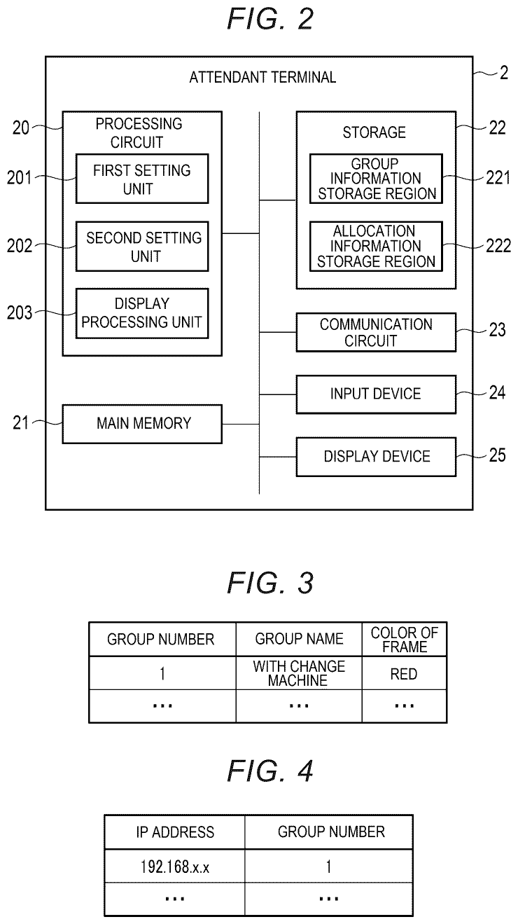

FIG. 2 is a block diagram exemplifying the attendant terminal 2. The attendant terminal 2 includes a processing circuit 20, a main memory 21, a storage 22, a communication circuit 23, an input device 24, and a display device 25. The processing circuit 20, the main memory 21, the storage 22, the communication circuit 23, the input device 24, and the display device 25 are connected to one another in a manner that enables inputting and outputting signals therebetween.

The processing circuit 20 includes one or more circuits that execute a plurality of kinds of processing for a plurality of functions. For example, the circuits may be, but are not limited to, a processor, an ASIC (Application Specific Integrated Circuit), or an FPGA (Field-Programmable Gate Array). For example, the processor may be, but is not limited to, a CPU (Central Processing Unit) or a GPU (Graphics Processing Unit). The processing circuit 20 loads, in the main memory 21, programs stored in the main memory 21 or the storage 22. The processing circuit 20 executes the programs loaded in the main memory 21 to enable various kinds of processing to be executed.

The main memory 21 includes a nonvolatile memory region and a volatile memory region. The main memory 21 stores an operating system or programs in the nonvolatile memory region. The main memory 21 uses the volatile memory region as a work area in which data is rewritten as appropriate by the processing circuit 20. For example, the main memory 21 may include a ROM (Read Only Memory) as the nonvolatile memory region. For example, the main memory 21 may include a RAM (Random Access Memory) as the volatile memory region.

The storage 22 may include one or more storage devices. For example, the storage device(s) may include an HDD (Hard Disk Drive) or a semiconductor storage medium such as an SSD (Solid State Drive) and are not limited to these media. The storage 22 stores the programs explained above, data used by the processing circuit 20 for performing various kinds of processing, and data generated by the processing of the processing circuit 20.

The storage 22 can include a group information storage region 221. The group information storage region 221 includes information about groups, referred to herein as “group information,” which may be persisted in a group setting table within the group storage region 221.

As used herein, a “group” is a set of one or more full self-service registers 1. Groups can be optionally set for organizing the full self-service registers 1. For example, groups may be set based on different types among the full self-service registers 1. For example, a group may include those of the full self-service registers 1 including change machines. As another example, a group may include those of the full self-service registers 1 not including change machines.

The group information for each group can include a group number, also referred to herein as a “group identifier.” The group number is a number identifying the group. The group number may be used to link other parts of the group information to full self-service registers 1 in allocation information, as explained below.

The group information for each group can also include a group name. As used herein, a “group name” is a designation identifying a category of full self-service registers 1 associated with one or more common characteristics.

The group information for each group can also include a display form of the group. The display form of the group, also referred to herein as a “visual feature,” defines how register information received from full self-service registers 1 assigned to that group via the communication circuit 23, is displayed. For example, the display form of the group may designate a display region where the register information is to be displayed for that group, referred to herein as a “register information display region.” The display form of the group may include one visual element or a plurality of visual elements within the register information display region such as a color, a pattern, a shape, or a size. For example, in the following explanation, the display form of the group will include a color of a frame of the register information display region.

The “register information,” also referred to herein as “monitoring information,” is information concerning the full self-service registers 1. The register information may be transmitted from one of the full self-service registers 1 to the attendant terminal 2. The register information can include a state of one of the full self-service registers 1. Examples of the state include “waiting,” “registering,” and “checking out.” The “waiting” state begins when one customer finishes checkout, and ends when the next customer begins commodity registration. The “registering” state begins when a customer starts the commodity registration and ends when the customer starts checkout. The “checking out” state begins when a customer starts checkout and ends when the customer finishes the checkout. If the state of one of the full self-service registers 1 is the registering state, the register information can include registration information. The “registration information” can include, for each of a group of registered commodities, information concerning the registered commodity. The information concerning the registered commodity can include one or more of a commodity name, a price, a quantity, and a commodity amount. The “commodity name” is a name assigned to the registered commodity. The price is a price for purchasing the registered commodity. The quantity is the number of registered commodities identified by the same identification information. The commodity amount is an amount calculated based on a product of the price and the quantity. If one of the full self-service registers 1 includes a change machine, the register information can further include a state of the change machine. For example, the state of the change machine may include an amount of coins in the change machine. The register information may include other types of information concerning the full self-service registers 1 and is not limited to the examples explained above.

The storage 22 can also include an allocation information storage region 222. The allocation information storage region 222 includes information about the full self-service registers 1, referred to herein as “allocation information,” which may be persisted in an allocation setting table within the allocation information storage region 222. The allocation information storage region 222 may store allocation information concerning all of the plurality of full self-service registers 1. Alternatively, the allocation information storage region 222 may store allocation information for only some of the plurality of full self-service registers 1.

The allocation information can include IP (Internet Protocol) addresses of the full self-service registers 1. In the following explanation, an “IP address” shall indicate an IP address of one of the full self-service registers 1. The IP address may be used for identifying the corresponding one of the full self-service registers 1.

The allocation information can further include group numbers of groups to which the full self-service registers 1 are assigned. The full self-service registers 1 may be linked to corresponding portions of the group information by the group numbers.

The communication circuit 23 is a circuit including various interfaces for transmitting and receiving signals. The communication circuit 23 communicably connects the attendant terminal 2 to other devices via the network NW. For example, the communication circuit 23 is configured to communicate with the full self-service registers 1 via the network NW.

The input device 24 is a device capable of inputting an instruction or information to the attendant terminal 2. The input device 24 may include, for example, a keyboard. As another example, although the input device 24 and the display device 25 are illustrated as separate devices, the input device 24 and the display device 25 may instead be integrated, e.g., into a single touch screen.

The display device 25 is a device capable of displaying various images according to control by the processing circuit 20. For example, the display device 25 may be a display panel such as a liquid crystal display, an EL (Electroluminescence) display, or the like.

Hardware components of the attendant terminal 2 are not limited to the components explained above. In practice, the attendant terminal 2 enables omission of and changes to the components explained above and addition of new components as appropriate.

Units implemented by the processing circuit 20, also referred to herein as “means” or “functions,” will now be explained. The processing circuit 20 is configured to execute a first setting unit 201, a second setting unit 202, and a display processing unit 203.

The first setting unit 201 sets allocation information based on user operation of the attendant terminal 2. The user operation may involve the attendant inputting an instruction or information to the attendant terminal 2 using the input device 24. For example, setting the allocation information may involve the first setting unit 201 storing allocation information in the allocation information storage region 222, specifically in the allocation setting table. The first setting unit 201 may later retrieve the persisted allocation information, e.g., based on IP addresses of the full self-service registers 1 to determine group numbers associated with the IP addresses. Accordingly, storing the allocation information in the allocation setting table enables usage of the allocation information to perform various operations according to embodiments.

The second setting unit 202 sets group information based on user operation of the attendant terminal 2. For example, setting the group information may involve the second setting unit 202 storing group information in the group information storage region 221, specifically in the group setting table. The second setting unit 202 may later retrieve the persisted group information, e.g., based on the group numbers to determine visual features associated with group numbers of groups. Accordingly, storing the group information in the group setting table enables usage of the group information to perform various operations according to embodiments.

The display processing unit 203 causes the display device 25 to display various images.

FIG. 3 is a diagram illustrating a configuration example of the group setting table according to some embodiments. Group information of groups is stored in the group setting table within the group information storage region 221. In the example illustrated in FIG. 3, the group information associates, for each group: a group number, a group name, and a color of a frame of the register information display region. This includes a group identified by the group number “1,” which has a group name of “WITH CHANGE MACHINE,” and which is associated with a red frame for its register information display region.

FIG. 4 is a diagram illustrating a configuration example of the allocation information storage region setting table. Allocation information of the full self-service registers 1 is stored in the allocation setting table within the allocation information storage region 222. In the example illustrated in FIG. 4, the allocation information associates, for each of the full self-service registers 1, an IP address and a group number. This includes one of the full self-service registers 1 with an IP address of “192.168.x.x,” which is assigned to the group identified by the group number “1.”

### Display Example

A display example of the display device 25 will now be explained.

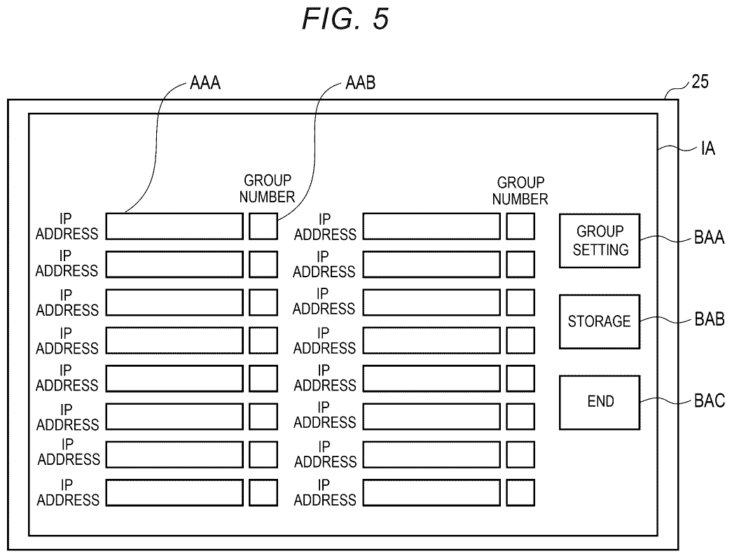

FIG. 5 is a diagram illustrating a display example of an allocation setting screen IA. The display device 25 displays the allocation setting screen IA. The allocation setting screen IA is an image for a user interface through which information can be input for setting allocation information for one or more of the full self-service registers 1. In the following explanation, the allocation information being input via the user interface of the allocation setting screen IA is referred to as “allocation setting information.” The allocation setting information can include an IP address for each of the full self-service registers 1. The allocation setting information can further include, for each of the full self-service registers 1, a group number of a group to which the full self-service register 1 is assigned.

The allocation setting screen IA can further include, for each of the full self-service registers 1, an IP address input field AAA and a group number input field AAB. Each IP address input field AAA is an input field for inputting an IP address of the allocation setting information. Each group number input field AAB is an input field for inputting a group number of the allocation setting information.

The allocation setting screen IA can further include a group setting button BAA. The group setting button BAA is a button that may be selected to input a display instruction for a group setting screen IB explained below. The display instruction for the group setting screen IB is an instruction for causing the display device 25 to display the group setting screen IB.

The allocation setting screen IA can further include a storage button BAB. The storage button BAB is a button that may be selected to input a setting instruction for allocation information. The setting instruction for the allocation information is an instruction for setting the allocation information based on the allocation setting information input via the user interface of the allocation setting screen IA.

The allocation setting screen IA can further include an end button BAC. The end button BAC is a button that may be selected to input an end instruction for the setting of the allocation information. The end instruction for the setting of the allocation information is an instruction to stop the display of the allocation setting screen IA by the display device 25 and to end the setting of the allocation information.

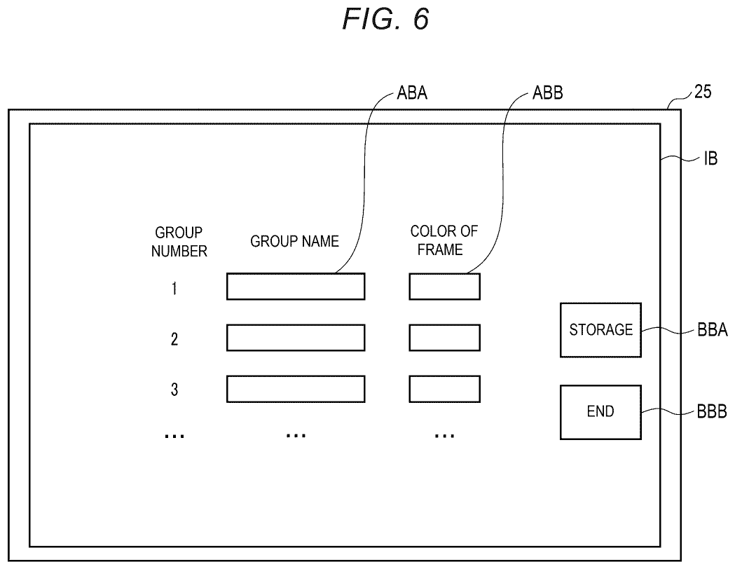

FIG. 6 is a diagram illustrating a display example of the group setting screen IB. The group setting screen IB is an image for a user interface through which information can be input for setting group information for one or more groups. In the following explanation, the group information being input via the user interface of the group setting screen IB is referred to as “group setting information.” In the example of FIG. 6, each group for which group information is being set is referred to as a “target group,” and each target group is identified by a group number. The group setting information can include a group name for each target group. The group setting information can further include, for each target group, a display form such as a color for frames.

The group setting screen IB can further include, for each target group, a group name input field ABA and a display form input field ABB. Each group name input field ABA is an input field for inputting a group name of the group setting information. Each display form input field ABB is an input field for inputting a display form of the group setting information.

The group setting screen IB can further include a storage button BBA. The storage button BBA is a button that may be selected to input a setting instruction for the group information. The setting instruction for the group information is an instruction for setting the group information based on the group setting information input via the user interface of the group setting screen IB.

The group setting screen IB can further include an end button BBB. The end button BBB is a button that may be selected to input an end instruction for the setting of the group information. The end instruction for the setting of the group information is an instruction to stop the display of the group setting screen IB by the display device 25 and to end the setting of the group information.

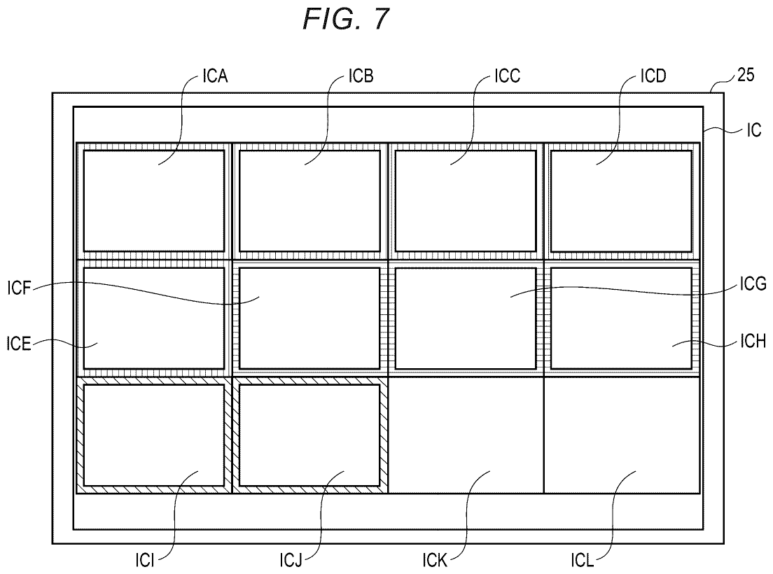

FIG. 7 is a diagram illustrating a display example of a list screen IC. The display device 25 displays the list screen IC.

The list screen IC is an image capable of displaying register information for each of the full self-service registers 1. In the example of FIG. 7, the list screen IC is capable of simultaneously displaying register information for each of twelve full self-service registers 1. However, in practice, the number of full self-service registers 1 for which register information may be simultaneously displayed is not limited to twelve.

The list screen IC includes a plurality of register information display regions. Each of the plurality of register information display regions displays register information of a different full self-service register 1. In the example of FIG. 7, the list screen IC includes twelve register information display regions obtained by vertically arranging sets of three register information display regions and horizontally arranging sets of four register information display regions. Note that the number of the plurality of register display regions is not limited to twelve. The arrangement of the plurality of register information display regions is not limited to the arrangement explained above.

Following the example of FIG. 7, if the number of the plurality of full self-service registers 1 in the store is twelve or less, the register information of the plurality of full self-service registers 1 can be displayed on one list screen IC. If the number of the plurality of full self-service registers 1 in the store is thirteen or more, the register information of the plurality of full self-service registers 1 can be displayed separately on a plurality of list screens IC.

Display order of the register information may start from a first register information display region ICA on the upper left and end at a twelfth register information display region ICL on the lower right. Here, the display order of the register information is: the first register information display region ICA, then a second register information display region ICB, then a third register information display region ICC, then a fourth register information display region ICD, then a fifth register information display region ICE, then a sixth register information display region ICF, then a seventh register information display region ICG, then an eighth register information display region ICH, then a ninth register information display region ICI, then a tenth register information display region ICJ, then an eleventh register information display region ICK, and then the twelfth register information display region ICL.

For example, the display order of the register information may prioritize register information of full self-service registers 1 for which allocation information has been set, over register information of full self-service registers 1 for which allocation information has not been set. The list screen IC may show register information display regions in order of their priorities, e.g., the first register information display region ICA having a higher priority than the second register information display region ICB. As another example, the display order of the register information may be based on the corresponding group numbers from the allocation information, e.g., showing the register information in ascending order of corresponding group numbers.

Here, a display example of register information will be explained with reference to FIG. 7. In this example, the number of the full self-service registers 1 in the store is twelve. In this example, allocation information is set for ten self-service registers 1 among the twelve full self-service registers 1. Allocation information is not set for two full self-service registers 1 among the twelve full self-service registers 1.

In this example, a group identified by a group number [1] includes five full self-service registers 1 among the ten full self-service registers 1 for which the allocation information is set. A group identified by a group number [2] includes three full self-service registers 1 among the ten full self-service registers 1 for which the allocation information is set. A group identified by a group number [3] includes two full self-service registers 1 among the ten full self-service registers 1 for which the allocation information is set.

The display device 25 may display the register information on the list screen IC in an ascending group order by group number, as explained below. In the first register information display region ICA, the second register information display region ICB, the third register information display region ICC, the fourth register information display region ICD, and the fifth register information display region ICE, the display device 25 may display the register information of the full self-service registers 1 belonging to the group identified by the group number [1]. In the sixth register information display region ICF, the seventh register information display region ICG, and the eighth register information display region ICH, the display device 25 may display the register information of the full self-service registers 1 belonging to the group identified by the group number [2]. In the ninth register information display region ICI and the tenth register information display regio ICJ, the display device 25 may display the register information of the full self-service register 1 belonging to the group identified by the group number [3]. In the eleventh register information display region ICK and the twelfth register information display region ICL, the display device 25 may display the register information of the full self-service registers 1 for which allocation information has not been set.

The display device 25 displays the register information display regions in the list screen IC in display forms corresponding to the groups, as explained below. Continuing the above example, the display device 25 displays the first register information display region ICA, the second register information display region ICB, the third register information display region ICC, the fourth register information display region ICD, and the fifth register information display region ICE in the display form of the group identified by the group number [1]. For example, the display device 25 may display the outer frames in a first color for each of the first register information display region ICA, the second register information display region ICB, the third register information display region ICC, the fourth register information display region ICD, and the fifth register information display region ICE. These outer frames are illustrated as having vertical stripes in the example of FIG. 7.

The display device 25 may display the sixth register information display region ICF, the seventh register information display region ICG, and the eighth register information display region ICH in the display form of the group identified by the group number [2]. For example, the display device 25 may display the outer frames in a second color for each of the sixth register information display region ICF, the seventh register information display region ICG, and the eighth register information display region ICH. The second color is a color different than the first color. These outer frames are illustrated as having horizontal stripes in the example of FIG. 7. The display device 25 may display the ninth register information display region ICI and the tenth register information display region ICJ in the display form of the group identified by the group number [3]. For example, the display device 25 may display the outer frames in a third color for each of the ninth register information display region ICI and the tenth register information display region ICJ. The third color is a color different than the first color and the second color. These outer frames are illustrated as having diagonal stripes in the example of FIG. 7. The display device 25 may display the eleventh register information display region ICK and the twelfth register information display region ICL in a default display form. For example, the default display form may specify displaying register information display regions with black-and-white frames.

### Processing Example

Processing by the attendant terminal 2 will now be explained. A processing procedure explained below is merely an example, and some of the described processing may be changed without departing from embodiments. Concerning the processing procedure explained below, omission, substitution, and addition of steps are possible according to embodiments.

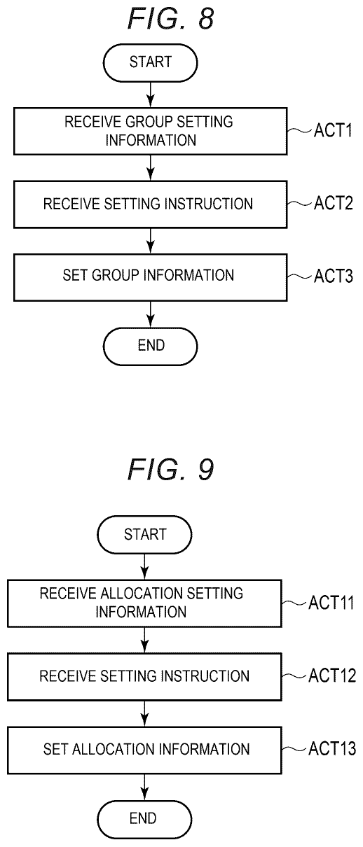

FIG. 8 is a flowchart exemplifying processing for setting group information performed by the processing circuit 20 of the attendant terminal 2. The processing circuit 20 can set group information based on user operation according to the processing exemplified in FIG. 8. For example, the processing circuit 20 may set group information for one or more groups based on the user operation. For example, the user operation may involve the attendant inputting group setting information for one or more groups using the input device 24. The processing exemplified in FIG. 8 may be performed by the second setting unit 202.

The processing circuit 20 receives group setting information (ACT1). In ACT1, for example, the processing circuit 20 may receive group setting information for one or more groups based on user operation. For example, the attendant may input group setting information for each of the groups on via the user interface of the group setting screen IB using the input device 24.

The processing circuit 20 then receives a setting instruction for group information (ACT2). In ACT2, the processing circuit 20 may receive the setting instruction for the group information based on selection of the storage button BBA. Here, the attendant may select the storage button BBA on the group setting screen IB using the input device 24.

The processing circuit 20 then sets group information based on group setting information specified by the setting instruction for the group information (ACT3). In ACT3, for example, the processing circuit 20 may set group information for one or more groups based on the group setting information. As explained above, setting the group information may involve the processing circuit 20 storing the group information in the group setting table, which enables usage of the group information to perform various operations according to embodiments.

As explained above, the attendant terminal 2 can set the group information based on the user operation. The attendant terminal 2 can set the group information in a manner that enables the attendant to thereafter easily monitor the full self-service registers 1 for each of the groups.

As explained above, the group information can include different display forms corresponding to different groups. Accordingly, based on the user input for the different display forms, the attendant terminal 2 can set the display forms of the groups in a manner that simplifies the monitoring by the attendant of the full self-service registers 1 for each of the groups.

As just one example, the display forms of the groups may include colors for the register information display regions, e.g., colors for their outer frames. Accordingly, based on differences in color within register information display regions of different groups, the attendant can easily identify the groups.

As mentioned above, the group information for each group can include a group name. The display device 25 can display the group names to assist the attendant in more easily comprehending the organization of the full self-service registers 1 into the groups. As explained above, one group may include full self-service registers 1 that include change machines, while another group may include full self-service registers 1 that do not include change machines. As explained above, such characteristics may be conveyed by names such as “WITH CHANGE MACHINE.”

FIG. 9 is a flowchart exemplifying processing for setting allocation information performed by the processing circuit 20 of the attendant terminal 2. The processing circuit 20 can set allocation information based on user operation according to the processing exemplified in FIG. 9. For example, the processing circuit 20 may set allocation information for one or more full self-service registers 1 among the plurality of full self-service registers 1 based on user operation. Similar to the example discussed above, the user operation may involve the attendant inputting allocation setting information for the one or more full self-service registers 1 using the input device 24. The processing exemplified in FIG. 9 may be performed by the first setting unit 201.

The processing circuit 20 receives the allocation setting information (ACT11). In ACT11, for example, the processing circuit 20 may receive the allocation setting information for the one or more full self-service registers 1 based on user operation. For example, the attendant may input the allocation setting information for each of the one or more full self-service registers 1 via the user interface of the allocation setting screen IA using the input device 24.

The processing circuit 20 then receives a setting instruction for allocation information (ACT12). In ACT12, for example, the processing circuit 20 may receive the setting instruction for the allocation information based on selection of the storage button BAB. For example, the attendant may select the storage button BAB on the allocation setting screen IA using the input device 24.

The processing circuit 20 then sets allocation information based on the allocation setting information specified by the setting instruction for the allocation information (ACT13). In ACT13, for example, the processing circuit 20 may set the allocation information for the one or more full self-service registers 1 based on the allocation setting information. As explained above, setting the allocation information may involve the processing circuit 20 storing the allocation information in the allocation setting table, which enables usage of the allocation information to perform various operations according to embodiments.

As explained above, the attendant terminal 2 can set the allocation information based on the user operation. The attendant terminal 2 can set the allocation information for the full self-service registers 1 in a manner that simplifies the monitoring of the full self-service registers 1 by the attendant.

The allocation information may include the group numbers. Accordingly, based on a desired display order of the register information display regions for the full self-service registers 1 on the list screen IC, the attendant can designate group numbers preferentially. Such display order may be one that is simpler and more efficient to monitor overall among the register information display regions.

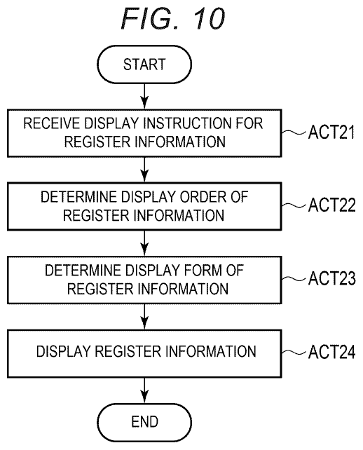

FIG. 10 is a flowchart exemplifying processing for displaying the list screen IC performed by the processing circuit 20 of the attendant terminal 2. According to the processing exemplified in FIG. 10, once allocation information and group information have been set for at least some of the full self-service registers 1, the processing circuit 20 can cause the display device 25 to display register information for each of the groups based on the set allocation information and the set group information. The processing circuit 20 causing the display device 25 to display register information for each of the groups includes the processing circuit 20 causing the display device 25 to display the register information in the display forms specified for each of the groups by the set group information. The processing circuit 20 causing the display device 25 to display the register information for each of the groups may include the processing circuit 20 causing the display device 25 to display the registration information according to a specified group order. The processing exemplified in FIG. 10 may be performed by the display processing unit 203.

The processing circuit 20 receives a display instruction for the register information (ACT21). In ACT21, for example, the processing circuit 20 may receive the display instruction for the register information based on user operation. The display instruction for the register information is an instruction for causing the display device 25 to display the list screen IC. For example, the user operation may involve the attendant inputting the display instruction for the register information using the input device 24.

The processing circuit 20 then determines the display order of the register information based on the display instruction for the register information (ACT22). In ACT22, for example, the processing circuit 20 may determine the display order of the plurality of full self-service registers 1 based on the set allocation information. For example, the processing circuit 20 can determine a display order that prioritizes the register information of full self-service registers 1 for which the allocation information has been set over the register information of any full self-service registers 1 for which allocation information has not been set. Alternatively or additionally, for example, the processing circuit 20 can determine a display order that displays groups in ascending order by group numbers from the set allocation information.

The processing circuit 20 then determines a display form(s) of the register information based on the display instruction for the register information (ACT23). In ACT23, for example, the processing circuit 20 may determine a display form of the register information for each of the plurality of full self-service registers 1, based on the set allocation information of the full self-service registers 1 and the set group information of the groups. In particular, processing circuit 20 can determine the group numbers of the groups to which the full self-service registers 1 are assigned, from the set allocation information, the group numbers being associated, e.g., with IP addresses. Then, the processing circuit 20 can determine the display forms for the groups identified by those group numbers, from the set allocation information. Furthermore, the processing circuit 20 can determine default display forms for the register information of the full self-service registers 1 for which allocation information has not been set. The display forms of the register information apply to the register information display regions where the register information is displayed. For example, the display forms of the register information display regions may include different colors of the outer frames of the register information display regions.

The processing circuit 20 then causes the display device 25 to display the register information (ACT24). In ACT24, for example, the processing circuit 20 may cause the display device 25 to update such that the display device 25 displays the register information based on a determined display order. This includes the processing circuit 20 causing the display device 25 to display, in the register information display regions of the list screen IC, the register information of the full self-service registers 1 for which the allocation information has been set.

As explained above, the attendant terminal 2 can cause the display device 25 to display the register information in a group order, e.g., in ascending order by group number. Accordingly, the attendant terminal 2 can cause the display device 25 to display the register information in an order that enables efficient recognition of the groups by the attendant based on relative display positions. In other words, the attendant terminal 2 can cause the display device 25 to display the register information in a manner that improves visibility of the register information for monitoring of a plurality of full self-service registers 1.

For example, the processing circuit 20 may cause the display device 25 to update such that the display device 25 displays the register information based on the determined display forms of the register information, i.e., to display, for each of the groups, the register information for each of the full self-service registers 1 assigned thereto, in a manner that includes the determined display form therefor. The processing circuit 20 can cause the display device 25 to display, in the display forms specified for each of the groups, the register information display regions where the register information is displayed for the full self-service registers 1 for which the allocation information has been set. For example, the processing circuit 20 may cause the display device 25 to display the register information display regions with outer frames of specified colors.

As explained above, the attendant terminal 2 can cause the display device 25 to display the register information in display forms specified for each of the groups. Based on specified display forms, the attendant terminal 2 can cause the display device 25 to display the register information in a manner that enables efficient recognition of the register information by the attendant. In other words, the attendant terminal 2 can improve visibility of display for monitoring the plurality of full self-service registers 1.

For example, as discussed above, different display forms (e.g., different colors for outer frames) may be associated with groups having different characteristics. Accordingly, displaying register information with different display forms may allow for more quickly identifying displayed register data for full self-service registers 1 having specific characteristics, which, by extension, may allow for more quickly identifying problems concerning the usage of such full self-service registers 1, e.g., based at least in part on states included in the displayed register information.

As discussed above, in ACT24, the processing circuit 20 may cause the display device 25 to display the register information according to specified display forms for each of the groups and according to a determined group order. However, as another example, the processing circuit 20 may cause the display device 25 to display the register information in only one of such manners. In other words, the processing circuit 20 may cause the display device 25 to display the register information according to specified display forms for each of the groups, but not based on group order. Alternatively, the processing circuit 20 may cause the display device 25 to display the register information according to a determined group order, but not based on specified display forms for each of the groups. In this case, the processing circuit 20 may skip checking the group information for identifying specified display forms.

As explained above, the attendant terminal 2 can cause the display device 25 to display the register information for each of the groups based on the allocation information. Accordingly, the attendant terminal 2 can cause the display device 25 to display the register information in a manner that enables efficient recognition of the groups by the attendant. In other words, the attendant terminal 2 can improve the visibility of display for various groups to simplify the monitoring of the plurality of full self-service registers 1.

### Other Embodiments

In the embodiments explained above, the full self-service registers 1 are explained as examples of the transaction processing devices in which checkout operations by customers are possible. However, embodiments may alternatively be performed wherein transaction processing devices for performing checkout operations are separate from devices for performing commodity registration operations. In this example, the devices that may be used by customers to perform commodity registration operations, may be either portable devices or stationary devices that configure a self-service checkout system. For example, portable devices may be used that are dedicated terminals mounted on shopping carts, which may be configured in advance by the store. As another example, portable devices may be used that are owned by the customers themselves.

The embodiments explained above can be applied to transaction processing devices, which customers may use to perform transaction operations. The transaction processing devices are not limited to transaction processing devices that also provide functionalities for performing checkout operations by customers. The transaction processing devices used by customers for performing transaction operations may be separate from transaction processing devices used by customers for performing checkout operations.

Although described as being included by the attendant terminal 2, the units implemented by the processing circuit 20 may instead be implemented by a separate computer (e.g., server computer) capable of communicating with the attendant terminal 2. In this case, the separate computer may transmit information to the attendant terminal 2 that causes the display device 25 to display various images.

Although being described as all being included by the same device (by the attendant terminal 2), the units implemented by the processing circuit 20 are not limited to being implemented by a single device. The units may instead be implemented in a distributed manner by a plurality of devices.

The embodiments explained above may be executed as a method by a device. The embodiments explained above may also by be performed using a program that causes a computer to execute the functions. The embodiments explained above may be performed using a recording medium storing the program.

Each of one or more circuits within the processing circuit 20 may execute one or more kinds of processing. Alternatively, if the processing circuit 20 includes only a single circuit, the single circuit may execute all of a plurality of kinds of processing. Furthermore, if the processing circuit 20 includes a plurality of circuits, the plurality of circuits may be included in one device or may be distributed among a plurality of devices.

The program described above may be stored on the device according to embodiments, or may be transmitted to the device from an external source. In the latter case, the program may be transmitted via a network or may be transmitted via a recording medium. The recording medium is a non-transitory, tangible medium. The recording medium is also a computer-readable medium. The recording medium is one that is capable of storing a program, such as a CD-ROM or a memory card, and can be read by a computer such as attendant terminal 2 to execute the program and perform the embodiments explained above.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. An attendant terminal computer configured to monitor a plurality of transaction processing apparatuses that are used by customers for performing transactions, the attendant terminal computer comprising:
a display panel;
a communication circuit configured to communicate with the plurality of transaction processing apparatuses; and
a processing circuit configured to execute a program stored in memory of the attendant terminal computer, to perform steps for managing the display panel, wherein the steps include:
determining group identifiers associated with groups to which the plurality of transaction processing apparatuses are assigned;
determining, based on the determined group identifiers, visual features for displaying monitoring information received via the communication circuit from the plurality of transaction processing apparatuses; and
updating, for each of the groups, the display panel to display the monitoring information for one or more of the plurality of transaction processing apparatuses assigned to the group, in a manner that includes a determined visual feature of the group.

2. The attendant terminal computer according to claim 1, further comprising:
a storage device, wherein the steps further include:
persisting, in the storage device, group information that associates the group identifiers with the visual features; and
retrieving the persisted group information to determine the visual features for the groups.

3. The attendant terminal computer according to claim 1, further comprising:
a storage device, wherein the steps further include:
persisting, in the storage device, allocation information that associates internet protocol (IP) addresses of the plurality of transaction processing apparatuses with the group identifiers; and
retrieving the persisted allocation information to determine the group identifiers for the groups.

4. The attendant terminal computer according to claim 1, wherein the steps further include:
updating the display panel to display the monitoring information in an order that is based on the group identifiers.

5. The attendant terminal computer according to claim 1, wherein the plurality of transaction processing apparatuses include transaction processing apparatuses located at different positions in a store, and updating the display panel includes causing the display panel to simultaneously display the monitoring information for transaction processing apparatuses located at different positions.

6. The attendant terminal computer according to claim 1, wherein the visual features of the groups include a plurality of different colors respectively associated with the groups, and updating the display panel includes causing the display panel to display outer frames of regions of the monitoring information in the different colors.

7. The attendant terminal computer according to claim 1, wherein updating the display panel includes causing the display panel to display group names associated with different characteristics of the groups.

8. A method of managing a display panel of an attendant terminal that is configured to monitor a plurality of transaction processing devices used by customers for performing transactions, the method comprising:
determining group identifiers associated with groups to which the plurality of transaction processing apparatuses are assigned;
determining, based on the determined group identifiers, visual features for displaying monitoring information received from the plurality of transaction processing apparatuses; and
updating, for each of the groups, the display panel to display the monitoring information for one or more of the plurality of transaction processing apparatuses assigned to the group, in a manner that includes a determined visual feature of the group.

9. The method according to claim 8, further comprising:
persisting group information that associates the group identifiers with the visual features; and
retrieving the persisted group information to determine the visual features for the groups.

10. The method according to claim 8, further comprising:
persisting allocation information that associates internet protocol (IP) addresses of the plurality of transaction processing apparatuses with the group identifiers; and
retrieving the persisted allocation information to determine the group identifiers for the groups.

11. The method according to claim 8, further comprising:
updating the display panel to display the monitoring information in an order that is based on the group identifiers.

12. The method according to claim 8, wherein the plurality of transaction processing apparatuses include transaction processing apparatuses located at different positions in a store, and updating the display panel includes causing the display panel to display the monitoring information for each of the groups simultaneously.

13. The method according to claim 8, wherein the visual features of the groups include a plurality of different colors respectively associated with the groups, and updating the display panel includes causing the display panel to simultaneously display the monitoring information for transaction processing apparatuses located at different positions.

14. The method according to claim 8, wherein updating the display panel includes causing the display panel to display group names associated with different characteristics of the groups.

15. A non-transitory, computer-readable medium comprising instructions that are executable in an attendant terminal computer that is configured to monitor a plurality of transaction processing apparatuses used by customers for performing transactions, wherein the instructions when executed cause the attendant terminal computer to carry out a method of managing a display panel thereof, and the method comprises:
determining group identifiers associated with groups to which the plurality of transaction processing apparatuses are assigned;
determining, based on the determined group identifiers, visual features for displaying monitoring information received from the plurality of transaction processing apparatuses; and
updating, for each of the groups, the display panel to display the monitoring information for one or more of the plurality of transaction processing apparatuses assigned to the group, in a manner that includes a determined visual feature of the group.

16. The non-transitory, computer-readable medium according to claim 15, wherein the method further comprises:
persisting group information that associates the group identifiers with the visual features; and
retrieving the persisted group information to determine the visual features for the groups.

17. The non-transitory, computer-readable medium according to claim 15, wherein the method further comprises:
persisting allocation information that associates internet protocol (IP) addresses of the plurality of transaction processing apparatuses with the group identifiers; and
retrieving the persisted allocation information to determine the group identifiers for the groups.

18. The non-transitory, computer-readable medium according to claim 15, wherein the method further comprises:
updating the display panel to display the monitoring information in an order that is based on the group identifiers.

19. The non-transitory, computer-readable medium according to claim 15, wherein the plurality of transaction processing apparatuses include transaction processing apparatuses located at different positions in a store, and updating the display panel includes causing the display panel to simultaneously display the monitoring information for transaction processing apparatuses located at different positions.

20. The non-transitory, computer-readable medium according to claim 15, wherein the visual features of the groups include a plurality of different colors respectively associated with the groups, and updating the display panel includes causing the display panel to display outer frames of regions of the monitoring information in the different colors.
